(19) United States
(12) Patent Application Publication
(10) Pub. No.: US 2006/0146551 A1
(43) Pub. Date: Jul. 6, 2006

(54) Control arrangement for an illuminating system of a motor vehicle

(75) Inventor: Tilo Schweers, Pforzheim (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/523,705

(22) PCT Filed: Jul. 19, 2003
(86) PCT No.: PCT/EP03/07911

§ 371 Date: Nov. 4, 2005

(30) Foreign Application Priority Data
Aug. 7, 2002 (DE) 102 36 127.4

(51) Int. Cl. B60Q 1/00

(52) U.S. Cl. 362/465

(57) ABSTRACT

A control arrangement for an illuminating system of a motor vehicle has a control unit. The control unit detects the activation of different light functions. According to the detected light function, the control unit controls an adjusting device of a headlight range adjusting system for adjusting an illumination of the surroundings of the motor vehicle.

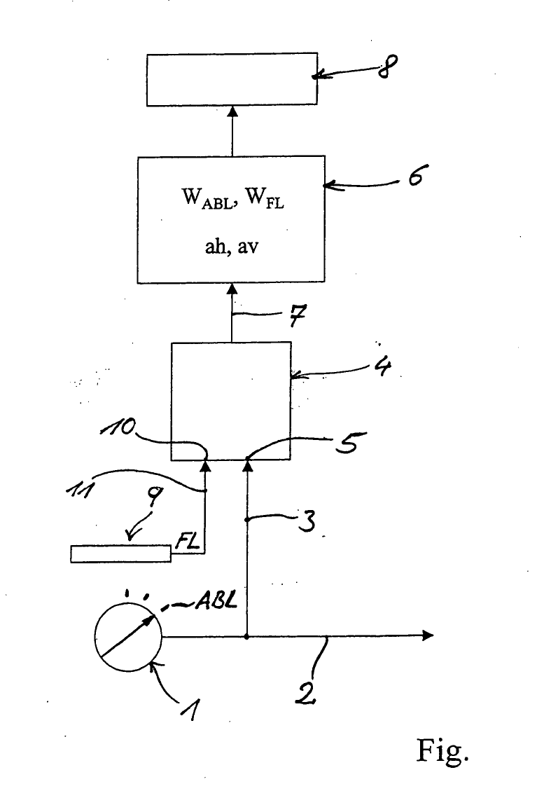

### BACKGROUND AND SUMMARY OF THE INVENTION

This application claims the priority of German patent application 102 36 127.4, filed Aug. 7, 2002 (PCT International Application No. PCT/EP2003/007911, filed Jul. 19, 2003) the disclosure of which is expressly incorporated by reference herein.

The invention relates to a control arrangement for an illuminating system of a motor vehicle.

The illuminating system of a motor vehicle contains different light functions. Thus, in German patent document DE 43 41 058 C1 lamps are provided, for example, for the fog lights, the high beams, and the driving beams, as well as for the stopping and parking lights on the front side. The lamps are controlled by means of a microcomputer, via switching end phases connected thereto. One problem with such systems is that an individual headlight (for example, a low beam or driving beam, high beam) frequently cannot simultaneously comply with different specific regulations (such as state-specific certification regulations) regarding its basic optical setting.

In some cases, particular regulations may be met by adjusting an optical reflector assigned to the headlight corresponding to the regulation in question. For example, in the case of headlights with separate reflectors for the driving light and the high beam, these reflectors can be adjusted individually in order to achieve the required illumination of the environment. However, in the case of headlights with a single two-filament bulb and a common reflector for the driving light and the high beam, this is not possible. The same is true of separate reflectors and illuminating devices when the reflectors are rigidly connected with one another. In these cases, only one light function (for example, the driving light or the high beam) can then be correspondingly adapted to specific regulations. This disadvantage can be avoided by keeping a special toolset for the specific regulations in order to produce specific reflectors. However, this is a high cost technique.

One object of the invention is to provide an illuminating system that can be adapted to satisfy different specific requirements in a cost-effective manner.

This and other objects and advantages are achieved by the control arrangement according to the invention, which uses a headlight range adjustment which is frequently present in the vehicle in any event. (Such a headlight range adjustment for vehicle headlights is known, for example, from German Patent Document DE 197 32 964 A1.) Furthermore, according to the invention, the headlight range adjustment system is connected to a control unit that is designed to detect different light functions (such as low beams, high beams) as input signals. As a function of the actually detected light function, the control unit controls an adjusting device of the headlight range adjustment to adjust illumination of the environment of the motor vehicle. Such a control arrangement has the advantage that, by means of conventional technical devices, a required optical illumination of the environment of a motor vehicle can be achieved in a cost-effective manner.

To control the adjusting device, the control unit preferably uses at least one control signal which represents a predetermined adjusting value of at least one physical quantity (for example, angle, path). This physical quantity can also be called an adjusting quantity.

An adjusting value of the same physical quantity can preferably be changed; that is, can be predetermined in different ways, permitting a technically simple adaptation of light functions to different requirements. In this manner, for example, regulations for illuminating the surroundings can also be satisfied without new components, if the regulations change in the course of the operating time of the motor vehicle. In addition, the control arrangement can contain a type of “databank” which already contains predetermined adjusting values for different marginal conditions (such as state-specific regulations). As a function of the actual marginal condition, the closest “fitting” adjusting value can then be selected in the control arrangement and can, for example, be read out of a memory unit.

In order to change the adjusting values as required, the latter are filed, for example, in an writable memory unit or the like, which may be a component of the control unit.

In a preferred embodiment, the adjusting device adjusts an adjusting object, preferably a reflector for a headlight. In the case of a particular active light function, the adjusting object is in a basic position. As soon as another light function is activated, the adjusting object is changed into an adjusting position corresponding to the adjusting value or values predetermined for that light function. Preferably, several light functions are present to which different adjusting values or adjusting positions are assigned in each case. As soon as the original light function is activated again, the adjusting device changes the adjusting object back into the basic position.

Such automatic adjustment can also be used for a manual headlight range adjustment. However, elimination of the manual adjustment, and exclusive use of the automatic adjustment is also conceivable.

A preferred embodiment of the reflectors can still be used in a cost-saving manner by means of the headlight range adjustment and the control unit, even if the light functions with respect to the illumination have to meet different requirements (for example, state-specific certification regulations). Changed reflectors and the tools required for this purpose are therefore superfluous.

The low beam and the high beam are preferably provided as different light functions. In an advantageous embodiment, the adjusting object is in the basic position when the low beam is activated. If the low beam is switched to the high beam during driving, the control unit triggers the headlight adjusting range system and adjusts the adjusting object by a predetermined adjusting value or several predetermined adjusting values.

The physical quantity preferably is an angle of rotation. For example, a reflector, as an adjusting object, is adjusted by a predetermined angle of rotation.

The adjusting object can preferably be adjusted about several axes of rotation, so that the illumination system can still more flexibly be adapted to different regulations.

Other objects, advantages and novel features of the present invention will become apparent from the following detailed description of the invention when considered in conjunction with the accompanying drawings.

### BRIEF DESCRIPTION OF THE DRAWINGS

The single FIGURE is a schematic block diagram of the control arrangement according to the invention.

### DETAILED DESCRIPTION OF THE DRAWINGS

By means of a rotary light switch, the driver of a motor vehicle can successively activate different light functions, for example, the low beam ABL (=driving beam).

By way of a line 2, the rotary light switch 1 is connected to a control unit (not shown) for controlling various lamps of the illuminating system of the motor vehicle. In addition, the rotary light switch 1 is also connected by a signal line 3 (which may also be several lines) to an electronic control unit 4. In this way, an input signal is applied to a first control input 5 of the electronic control unit 4, which input signal corresponds to the light function activated by the rotary light switch 1.

By operating a steering gear arm or lever 9 (schematically illustrated in the FIGURE), the high beam FL can be activated. An input signal, which corresponds to the condition of the light function which can be activated by the steering gear arm 9, is applied to a second control input 10 of the control unit 4. By means of a signal line 11 (which may also be several lines), the steering gear lever 9 is connected to the second control input 10.

The control unit 4 detects the low beam ABL and high beam FL light functions as well as additional light functions. The control unit 4 triggers an adjusting device 6 of a headlight range adjustment system as a function of the detected active light function by means of a control line 7 (which may also be several lines). Control signals, which cause the adjusting device 6 to adjust a reflector 8 of a headlight, are applied to the control line 7. For example, angles of rotation and/or axes of rotation defined for different light functions for a corresponding adjustment of the reflector 8 are filed in a memory of the control unit 4. Advantageously, these predetermined adjusting values can be adapted to requirements which have changed in the course of the operating time or change from one state to another, in that they are replaced by different predetermined adjusting values.

In a preferred embodiment, the adjusting device 6 is triggered as follows: In the basic position of the reflector 8 or of an assigned front headlight, the regulations for the illumination of the low beam ABL have been met. When a change-over occurs during driving, from the low beam ABL to the high beam FL, the control unit 4 triggers the adjusting device 6 by means of control signals such that the reflector 8 is adjusted about a defined axis of rotation (for example, about a horizontal axis ah or a vertical axis av) along a predetermined angle of rotation W_{FL}. In this case, the adjusting values are defined such that the illumination of the high beam FL, in turn, corresponds to the regulations. When a switching back to the “low beam ABL” position takes place, the adjusting device 6 is again triggered by the control unit 4 by means of corresponding output signals or predetermined adjusting values, so that the reflector 8 is returned into its basic position. The adjusting movement of the reflector 8, in turn, is a function of the horizontal axis of rotation ah and/or of the vertical axis of rotation av as well as of an angle of rotation W_{ABL} for the low beam.

If several axes of rotation are available, preferably a horizontal adjustment of the reflect 8 about the horizontal axis ah occurs first. If a transverse adjustment of the reflector 8 about the vertical axis av of the vehicle is also required in order to meet the regulation, the reflector is adjusted about the vertical axis av in a second step in order to adjust the reflector 8 or the assigned headlight.

This method is preferably suitable for light functions or lighting devices where a common reflector 8 is assigned to the low beam ABL and the high beam FL or where the reflector for the low beam ABL and the reflector for the high beam FL are rigidly connected with one another.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-4. (canceled)

5. A control arrangement for an illuminating system of motor vehicle, which control arrangement includes a control unit which detects an activation of different light functions as input signals; wherein,
as a function of the detected light functions said control unit triggers an adjusting device of a headlight range adjustment system for adjusting an illumination device for illuminating of the surroundings of a motor vehicle;
the adjusting device is triggered by means of at least one control signal representing a predetermined adjusting value of at least one physical quantity which characterizes said illuminating device;
the adjusting value is predeterminable in different state-specific manners.

6. The control arrangement according to claim 5, wherein the adjusting device adjusts a reflector for a headlight.

7. The control arrangement according to claim 6, wherein a common reflector is assigned to different light functions.

8. The control arrangement according to claim 7, wherein:
different light functions have mutually separate light devices, to which one reflector respectively is assigned; and
the reflectors are rigidly connected with one another.

9. The arrangement according to claim 6, wherein said different light functions include low beam light and high beam light.

10. The arrangement according to claim 6, wherein said physical quantity comprises an angle of rotation.

11. The arrangement according to claim 9, wherein the adjusting object is adjustable about at least one axis of rotation.
